(19) United States
(12) Patent Application Publication
(10) Pub. No.: US 2010/0296030 A1
(43) Pub. Date: Nov. 25, 2010

(54) OPTICAL FILM, POLARIZING PLATE, LIQUID CRYSTAL PANEL, LIQUID CRYSTAL DISPLAY, AND METHOD FOR PRODUCING OPTICAL FILM

(75) Inventors: Takashi Shimizu, Ibaraki-shi (JP); Akinori Nishimura, Ibaraki-shi (JP); Toshiki Omine, Ibaraki-shi (JP); Hirofumi Katami, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/783,752

(22) Filed: May 20, 2010

(30) Foreign Application Priority Data
May 20, 2009 (JP) 2009-122544
Mar. 29, 2010 (JP) 2010-076117

(51) Int. Cl. G02F 1/1335; G02B 5/30

(52) U.S. Cl. 349/96; 359/485; 427/553

(57) ABSTRACT

An optical film that includes an optical compensation layer having a refractive index anisotropy satisfying nx>ny>nz. The optical compensation layer contains a polyvinyl alcohol resin subjected to ultraviolet cross-linking with a cross-linking agent having at least two double bonds, where nx: a refractive index in a direction (a slow axis direction) in which an in-plane refractive index of the optical compensation layer reaches its maximum ny: a refractive index in a direction (a fast axis direction) that is orthogonal to the nx direction within a plane of the optical compensation layer nz: a refractive index in a thickness direction of the optical compensation layer that is orthogonal to each of the nx and ny directions.

The optical film has a high retardation developability and high retardation reliability, uses a material that is inexpensive as compared to polyimide and has a wide choice of solvents.

### CROSS-REFERENCE TO RELATED APPLICATION

This application claims priority from Japanese Patent Applications No. 2009-122544 filed on May 20, 2009 and No. 2010-076117 filed on Mar. 29, 2010. The entire subject matter of the Japanese Patent Applications is incorporated herein by reference.

### FIELD OF THE INVENTION

The present invention relates to an optical film, a polarizing plate, a liquid crystal panel, a liquid crystal display, and a method for producing the optical film.

### BACKGROUND OF THE INVENTION

Heretofore, optical films including optical compensation layers are used for various liquid crystal displays. An example of the optical film includes the one produced by forming a film by applying a solution in which polyimide is dissolved in a solvent on a base and drying the film of the applied solution (see JP8 (1996)-511812 A). When the optical film is arranged between a liquid crystal cell and a polarizer of a liquid crystal display, for example, an increase in a viewing angle of a display property in a liquid crystal display can be achieved. Therefore, the optical film is useful as a viewing angle compensation film of the liquid crystal cell.

### SUMMARY OF THE INVENTION

However, since polyimide is very expensive, the optical film has a problem in a production cost. Further, solvents in which polyimide can be dissolved are limited, and examples of the solvent that can be used include methyl isobutyl ketone, methyl ethyl ketone, ethyl acetate, and the like, which are not environmentally-friendly.

In contrast, a polyvinyl alcohol resin can use solvents such as water, ethanol, and the like, and a mixed solvent thereof, which are environmentally-friendly. However, generally, with respect to a film formed of a polyvinyl alcohol resin, the alignment thereof is easily deformed in hot and humid surroundings and the retardation reliability is low. For increasing the retardation reliability, there is a method in which the polyvinyl alcohol resin is subjected to cross-linking with boric acid. However, when an objective retardation is desired to be obtained with this method, the film formed of a polyvinyl alcohol resin is required to be thickened for compensating a decrease in an alignment (Δnxz) in the thickness direction due to addition of the boric acid. When the film is thickened in this manner, a vicious cycle is caused in which the retardation reliability is decreased and the boric acid should be further added. Further, thickening of the film also causes an increase in the production cost.

Hence, the present invention is intended to provide an optical film having high retardation developability and high retardation reliability that uses a material that can use an environmentally-friendly solvent and is inexpensive as compared to polyimide and a method for producing the optical film. Further, the present invention is intended to provide a polarizing plate, a liquid crystal panel, and a liquid crystal display using the optical film.

In order to achieve the aforementioned object, the optical film of the present invention is an optical film that includes an optical compensation layer having a refractive index anisotropy satisfying nx>ny>nz. The optical compensation layer contains a polyvinyl alcohol resin subjected to ultraviolet cross-linking with a cross-linking agent having at least two double bonds.

In nx>ny>nz:
nx: a refractive index in a direction (a slow axis direction) in which an in-plane refractive index of the optical compensation layer reaches its maximum;
ny: a refractive index in a direction (a fast axis direction) that is orthogonal to the nx direction within a plane of the optical compensation layer; and
nz: a refractive index in a thickness direction of the optical compensation layer that is orthogonal to each of the nx and ny directions.

The polarizing plate of the present invention is a polarizing plate that includes the optical film and a polarizer.

The liquid crystal panel of the present invention is a liquid crystal panel that includes a liquid crystal cell and an optical element. The optical element is the optical film or the polarizing plate, and the optical element is arranged at least one side of the liquid crystal cell.

The liquid crystal display of the present invention is a liquid crystal display that includes the optical element or the liquid crystal panel. The method for producing an optical film of the present invention is a method for producing an optical film that includes an optical compensation layer having a refractive index anisotropy satisfying nx>ny>nz. The method includes steps of forming a film (hereinafter, referred to as “coating film”) by applying a material for forming the optical compensation layer containing a polyvinyl alcohol resin and a cross-linking agent having at least two double bonds on a base; performing at least one of stretching and shrinking of a laminate of the base and the coating film; and irradiating the laminate with ultraviolet rays after performing at least one of the stretching and the shrinking.

According to the present invention, by using the polyvinyl alcohol resin to which the cross-linking agent is added, an optical film that has a wide choice of solvents at the time of forming a coating film and also has high retardation developability and high retardation reliability can be obtained at a low price.

### BRIEF DESCRIPTION OF THE DRAWINGS

FIG. 1 is a schematic cross sectional view showing an example of the structure of the polarizing plate of the present invention.

FIG. 2 is a schematic cross sectional view showing an example of the structure of the liquid crystal panel of the present invention.

FIG. 3 is a schematic cross sectional view showing an example of the structure of the liquid crystal cell provided at the liquid crystal panel of the present invention.

FIG. 4 is a schematic cross sectional view showing an example of the structure of the liquid crystal display of the present invention.

### DETAILED DESCRIPTION OF THE INVENTION

In the optical film of the present invention, it is preferable that an alignment Δnxz of the optical compensation layer in a thickness direction represented by the following formula is 0.01 or more. The upper limit of the Δnxz is, for example, 0.1, although it is not particularly limited. Δnxz is defined as Δnxz=nx−nz.

In the optical film of the present invention, the amount of the cross-linking agent to be added to the polyvinyl alcohol resin is preferably in the range from 0.5% by weight to 8% by weight, more preferably in the range from 1% by weight to 7% by weight, and further preferably in the range from 3% by weight to 6% by weight.

In the optical film of the present invention, it is preferable that an absolute value (ΔRth=|Rthᵢ−Rth_{f}|) of a difference between retardation (Rth_{f}) of the optical compensation layer in a thickness direction after allowing to stand still for 100 hours under an environment in which a temperature is 60° C. and a relative humidity is 90% and retardation (Rthᵢ) of the optical compensation layer in a thickness direction before allowing to stand still is 10 nm or less.

Rth is defined as Rth=(nx−nz)×d
d: thickness (nm) of the optical compensation layer

In the optical film of the present invention, since the polyvinyl alcohol resin is subjected to the ultraviolet cross-linking with the cross-linking agent, the alignment thereof is not easily deformed in hot and humid surroundings, and the ΔRth can be reduced. The ΔRth is preferably 8 nm or less and more preferably 5 nm or less.

In the optical film of the present invention, it is preferable that an absolute value (ΔRe==|Reᵢ−Re_{f}|) of a difference between front retardation (Re_{f}) of the optical compensation layer after allowing to stand still for 100 hours under an environment in which a temperature is 60° C. and a relative humidity is 90% and front retardation (Reᵢ) of the optical compensation layer before allowing to stand still is 5 nm or less.

Re is defined as Re=(nx−ny)×d
d: thickness (nm) of the optical compensation layer.

In the optical film of the present invention, since the polyvinyl alcohol resin is subjected to the ultraviolet cross-linking with the cross-linking agent, the alignment thereof is not easily deformed in hot and humid surroundings, and the ΔRe can be reduced. The ΔRe is preferably 4 nm or less and more preferably 3 nm or less.

Re=(nx−ny)×d

Next, the present invention will be explained in more detail. However, the present invention is not limited by the following description.

As described above, the optical film of the present invention is an optical film that includes an optical compensation layer having a refractive index anisotropy satisfying nx>ny>nz. The optical compensation layer contains a polyvinyl alcohol resin subjected to ultraviolet cross-linking with a cross-linking agent having at least two double bonds. Since the polyvinyl alcohol resin is subjected to the ultraviolet cross-linking with the cross-linking agent, an optical film having high retardation developability and high retardation reliability, the alignment thereof being not easily deformed in hot and humid surroundings, can be obtained. Further, the polyvinyl alcohol resin is very inexpensive as compared to polyimide and it has an advantage in a production cost.

As described above, in the optical film of the present invention, the optical compensation layer may be formed on a transparent film base, for example.

The method for producing an optical film of the present invention is a method in which a coating film is formed by applying a material for forming the optical compensation layer containing the polyvinyl alcohol resin and the cross-linking agent on a base, at least one of stretching and shrinking of a laminate of the base and the coating film is performed, and thereafter the polyvinyl alcohol resin is subjected to the ultraviolet cross-linking with the cross-linking agent by irradiating the laminate with ultraviolet rays. The thickness of the coating film is, for example, in the range from 5 μm to 300 μm, although it is not particularly limited.

The base is not particularly limited and may be, for example, a plastic base or an inorganic compound base such as a glass base. Examples of the plastic base include a base produced by a casting method, a base produced by forming a film from a molten polymer and then applying a stretching treatment or a shrinking treatment, and the like. Among them, since high application precision can be achieved, a plastic base, the mechanical strength thereof being increased by a stretching treatment, is preferred.

Further, the base is, for example, preferably a transparent film base formed of a polymer that has high transparency. It is because when such a base is used, a laminate in which an optical compensation layer is formed on the base can be directly used as an optical film.

Examples of the transparent film base include acryl, a cyclic olefin copolymer (CO C), a cyclic olefin polymer (COP), ethylene-vinyl acetate (EVA), methacryl-styrene (MS), polyethylene terephthalate (PET), polypropylene

(PP), polystyrene (PS), polycarbonate (PC), polymethyl methacrylate (PMMA), hydrogenated styrene-butadiene-styrene (SBS), polyamide (PA), polyethylene (PE), polymethylpentene (PMP), nylon (NY), a copolymer thereof, a blended product thereof, and the like.

It is preferable to use an acrylic resin for the transparent film base. The glass-transition temperature (Tg) of the acrylic resin is preferably 115° C. or higher, more preferably 120° C. or higher, further preferably 125° C. or higher, and particularly preferably 130° C. or higher. When the Tg is 115° C. or higher, the acrylic resin has high durability. The upper limit of the Tg of the acrylic resin is not particularly limited. However, in view of formability or the like, the Tg is preferably 170° C. or lower. The glass-transition temperature (Tg) can be obtained by a DSC method according to JIS K 7121.

As the acrylic resin, any appropriate acrylic resins can be employed within a range in which the advantages of the present invention are not impaired. However, preferable examples of the acrylic resin include polyacrylic acid ester, polymethacrylic acid ester (e.g., polymethyl methacrylate and the like), methyl methacrylate-acrylic copolymers, methyl methacrylate-methacrylic copolymers, methyl methacrylate-acrylic ester copolymers, methyl methacrylate-methacrylic ester copolymers, methyl methacrylate-acrylic ester-acrylic copolymers, methyl methacrylate-acrylic ester-methacrylic copolymers, methyl acrylate-styrene copolymers, methyl methacrylate-styrene copolymers, polymers having alicyclic hydrocarbon groups (e.g., a methyl methacrylate-cyclohexyl methacrylate copolymer, a methyl methacrylate-norbornyl acrylate copolymer, a methyl methacrylate-norbornyl methacrylate copolymer, and the like), and the like. More preferable examples of the acrylic resin include polyalkyl acrylate and polyalkyl methacrylate such as polymethyl acrylate and polymethyl methacrylate. It is to be noted that the alkyl group has preferably 1 to 6 carbon atoms. A further preferable example of the acrylic resin includes a methyl methacrylate resin containing methyl methacrylate as a main ingredient (in the range from 50% by weight to 100% by weight, and preferably in the range from 70% by weight to 100% by weight).

Specific examples of the acrylic resin include ACRYPET VH and ACRYPET VRL 20A produced by Mitsubishi Rayon Co., Ltd.; the acrylic resin having a ring structure in a molecule described in JP2004-70296 A; a high Tg acrylic resin obtained by intramolecular cross-linking and an intramolecular cyclization reaction; and the like. It is also preferable to use an acrylic resin having a lactone ring structure, an acrylic resin having a glutaric anhydride structure, and an acrylic resin having a glutarimide structure as the acrylic resin. It is because these acrylic resins have high durability, high transparency, and high mechanical strength.

Examples of the acrylic resin having a lactone ring structure include acrylic resins having lactone ring structures described in JP2000-230016 A, JP2001-151814 A, JP2002-120326 A, JP2002-254544 A, JP2005-146084 A, and the like. The acrylic resin having a lactone ring structure preferably has a lactone ring structure represented by the following general formula (1).

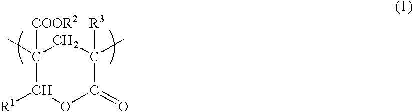

In the general formula (1), R¹, R², and R³ each represent a hydrogen atom or an organic residue having 1 to 20 carbon atoms; the organic residue may include an oxygen atom; and R¹, R², and R³ may be identical to or different from one another.

Examples of the acrylic resin having a glutaric anhydride structure include acrylic resins having glutaric anhydride structures described in JP2006-283013 A, JP2006-335902 A, JP2006-274118 A, WO2007/026659, and the like. The acrylic resin having a glutaric anhydride structure preferably has a glutaric anhydride structure represented by the following general formula (2).

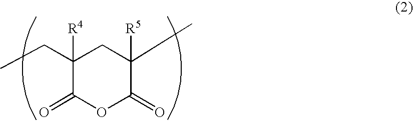

In the general formula (2), R⁴ and R⁵ each represent a hydrogen atom or an alkyl group having 1 to 5 carbon atoms; and R⁴ and R⁵ may be identical to or different from each other.

As described above, the material for forming the optical compensation layer contains the polyvinyl alcohol resin and the cross-linking agent.

An example of the polyvinyl alcohol resin includes a polyvinyl alcohol resin containing a repeat unit represented by the following structural formula (1). In this polyvinyl alcohol resin, the degree of polymerization n is not particularly limited, however may be, for example, in the range from 1500 to 5000, preferably in the range from 1800 to 4500, and more preferably in the range from 2000 to 4500. When the degree of polymerization n is 1500 or more, an optical film having high retardation developability (for example, the Δnxz is 0.004 or more), the alignment thereof being not easily deformed under humidified conditions, can be obtained. Further, when the degree of polymerization n is 5000 or less, a solution containing the polyvinyl alcohol resin can easily obtain an appropriate viscosity for the application that will be described later. Thus, an optical film with no application defects such as unfavorable streaks and the like, clouding, and unevenness can be obtained. Moreover, the polyvinyl alcohol resin is very inexpensive as compared to polyimide and it has an advantage in a production cost. Commercially available polyvinyl alcohol resins can be used as the polyvinyl alcohol resin. Examples of the commercially available polyvinyl alcohol resin include “JC40” (product name) produced by JAPAN VAM & POVAL CO., LTD.; “POVAL PVA 124” (product name) produced by Kuraray Co., Ltd.; “GOHSENOL NH-18” (product name) produced by Nippon Synthetic Chemical Industry Co., Ltd.; and the like.

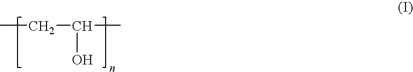

The polyvinyl alcohol resin may be a polyvinyl alcohol resin containing a repeat unit represented by the following structural formula (II). It is to be noted that the repeat unit is indicated as a block copolymer in the following structural formula (II) for convenience sake. However, the repeat unit is not limited thereto and it may be a random copolymer. Further, in the present invention, the degree of polymerization of the polyvinyl alcohol resin is n+m.

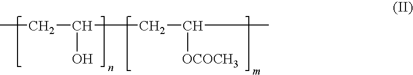

The degree of saponification S of the polyvinyl alcohol resin containing a repeat unit represented by the structural formula (II) that is represented by the following formula is preferably 98% or more.

S is defined as S=n/(n+m)×100.

When the degree of saponification S is 98% or more, an optical film having high retardation developability and high retardation reliability, the alignment thereof being not easily deformed under humidified conditions, can be obtained. The degree of saponification S is preferably 99% or more. Further, the polyvinyl alcohol resin is very inexpensive as compared to polyimide and it has an advantage in a production cost.

The cross-linking agent is not particularly limited as long as it has at least two double bonds, and examples thereof include methylenebisacrylamide (MBAA), hydantoin epoxy acrylate (HYEA) described in JP3 (1991)-237114 A and JP3 (1991)-237115 A, and the like. The MBAA is commercially available from Wako Pure Chemical Industries, Ltd., and the like. The amount of the cross-linking agent to be added to the polyvinyl alcohol resin is as described above.

Examples of the method for applying the material for forming the optical compensation layer on the base include a method in which the material is melted by heating and then applied, a method in which a solution in which the material is dissolved in a solvent is applied, and the like. The application of the material can be performed by appropriate methods such as a spin coating method, a roll coating method, a flow coating method, a printing method, a dip coating method, a casting method, a bar coating method, a gravure printing method, and the like.

The solvent is not particularly limited as long as the material for forming the optical compensation layer can be dissolved therein, and can be appropriately selected. For example, water, ethanol, and the like can be used as the solvent. One of the solvents may be used alone or two or more of them may be used in combination. Conventionally known optical films using polyimide cannot use water as the solvent because polyimide is insoluble in water, whereas the optical film of the present invention can reduce environmental loads by using, for example, water as the solvent. In the solution, with respect to the 100 parts by weight of the solvent, for example, the amount of the polyvinyl alcohol resin to be added is preferably in the range from 3 parts by weight to 30 parts by weight and more preferably in the range from 5 parts by weight to 15 parts by weight so that the viscosity suitable to the application can be obtained.

The method for stretching the laminate of the base and the coating film is not particularly limited, and examples thereof include a free end stretching method, a fixed end stretching method, and the like. The free end stretching method performs uniaxial stretching in a longitudinal direction and the fixed end stretching method performs uniaxial stretching in a width direction in a state where the laminate is fixed in a longitudinal direction.

Further, as described above, a coating film is formed by applying the material for forming the optical compensation layer on the base, and then the coating film is dried. With respect to the stretching of the laminate, the dried coating film and the base may be stretched after drying the coating film or the base on which the coating film is formed may be stretched before drying the coating film. The stretching may be performed by pulling both the base and the coating film. However, for example, for the following reason, it is also preferable to stretch the coating film indirectly by stretching only the base. When only the base is stretched, the coating film on the base is stretched indirectly by tension occurring in the base by this stretching. Further, normally, uniform stretching can be achieved more successfully by stretching a single layer than by stretching a laminate. Therefore, when only the base is uniformly stretched as described above, accompanying with this stretching, the coating film on the base can be stretched uniformly. When the coating film is stretched indirectly by stretching only the base, the optical films obtained can achieve uniform optical properties and variations in properties in the slow axis direction in particular can be prevented effectively. Therefore, optical films obtained in this manner are favorably adaptable to upsizing of screens of liquid crystal displays.

Conditions for stretching are not particularly limited and can be defined suitably according to, for example, the type of the base and the material for forming the optical compensation layer. However, the stretching direction is preferably in the width direction of the base. The draw ratio is preferably 7-fold or less, more preferably in the range from 1.05-fold to 4-fold, and further preferably in the range from 1.05-fold to 1.5-fold.

The optical film of the present invention can be produced by shrinking the laminate of the base and the coating film. Examples of the method for shrinking the laminate of the base and the coating film include methods in which the coating film on the base is indirectly shrank by shrinking the base, for example, by utilizing anisotropic change in dimension of the base or by using the base having active shrinking performance. At this time, for example, it is preferable to control the shrinkage ratio by using a stretching machine or the like. Examples of the method for controlling the shrinkage ratio include a method for relaxing the base in a direction of transfer by temporarily releasing a clip of the stretching machine, a method for gradually narrowing the interval of the clip of the stretching machine, and the like. The shrinkage ratio is preferably 0.5-fold or more and less than 1-fold.

The polyvinyl alcohol resin is subjected to ultraviolet cross-linking with the cross-linking agent by irradiating the laminate with ultraviolet rays after performing at least one of the stretching and the shrinking. Ultraviolet ray irradiation means are used for the irradiation of ultraviolet rays. Examples of the energy radiation source of the ultraviolet ray irradiation means include radiation sources such as high-pressure mercury lamps, halogen lamps, xenon lamps, metal halide lamps, nitrogen lasers, electron beam accelerators, radioactive elements, and the like. The amount of irradiation is preferably 150 mJ/cm² or more, and more preferably in the range from 200 mJ/cm² to 800 mJ/cm².

In the method for producing an optical film of the present invention, as described above, ultraviolet cross-linking is performed in a state where molecules are aligned by performing at least one of stretching and shrinking. Therefore, an optical film having high retardation developability and high retardation reliability can be obtained.

The optical compensation layer formed on the base in this manner has a refractive index anisotropy satisfying nx>ny>nz. The thickness of the optical compensation layer is preferably in the range from 1 μm to 30 μm. According to the present invention, since the retardation developability is high, the thickness of the optical compensation layer can be reduced. The Δnxz, ΔRth, and ΔRe of the optical compensation layer are as described above. The optical compensation layer may be directly used for the optical film of the present invention as a laminate with the base, or may be used for the optical film of the present invention as an optical compensation single-layer removed from the base.

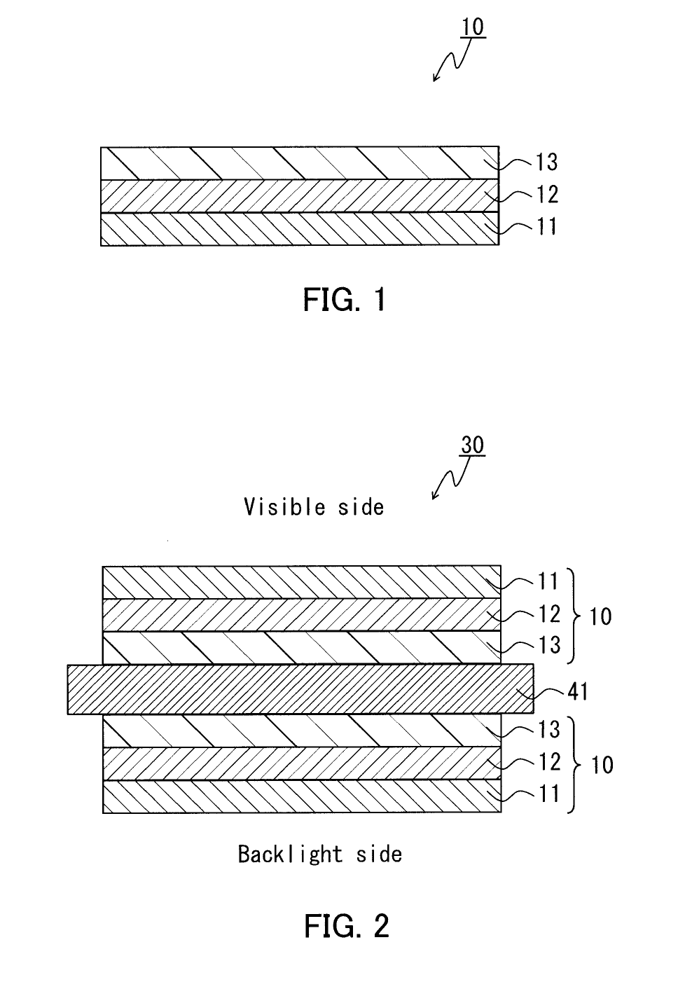

The polarizing plate of the present invention is a polarizing plate that includes an optical film and a polarizer, and the optical film is the optical film of the present invention. In the polarizing plate of the present invention, a polarizer is laminated on the side of the base or the side of the optical compensation layer of the optical film. It is to be noted that a laminate of a polarizer and the optical compensation single-layer that is removed from the base can be also used as a polarizing plate. On the polarizer, a protective layer may be formed. A schematic cross sectional view of FIG. 1 shows an example of the structure of the polarizing plate of the present invention. In FIG. 1, in order to make it clearly understandable, for example, the sizes and ratios of respective components differ from actual ones. As shown in FIG. 1, a polarizing plate 10 includes a protective layer 11, a polarizer 12, and an optical film 13 of the present invention. The polarizing plate 10 is constructed by laminating the protective layer 11, the polarizer 12, and the optical film 13 in this order. The thickness of the whole polarizing plate is, for example, in the range from 20 μm to 300 μm. By setting the thickness in the aforementioned range, the polarizing plate having high mechanical strength can be obtained.

An adhesive layer or an optical element (preferably the one showing isotropy) may be arranged between respective components (optical elements) of the polarizing plate. The “adhesive layer” is, for example, one obtained by bonding surfaces of adjacent optical elements and combining them with sufficient adhesive force and adhesive time. Examples of the material for forming the adhesive layer include conventionally known adhesive agents, pressure-sensitive adhesive agents, anchor coating agents, and the like. The adhesive layer may have a multilayer structure in which an anchor coating layer is formed on a surface of an adhesive body and an adhesive agent layer is formed thereon. Alternatively, the adhesive layer may be a thin layer (also called a hair-line) that is hardly noticeable to the naked eye.

The polarizer is not particularly limited and various types of polarizers can be used (for example, see JP2008-90263).

Any appropriate materials can be employed as a material for forming the protective layer. The protective layer is preferably a polymer film containing a cellulose resin, a norbornene resin, an acrylic resin, or an ester resin. The polymer film containing the cellulose resin can be obtained, for example, by a method described in Example 1 of JP7 (1995)-112446 A. The polymer film containing the norbornene resin can be obtained, for example, by a method described in JP2001-350017. The polymer film containing the acrylic resin can be obtained, for example, by a method described in Example 1 of JP2004-198952 A.

The protective layer may include a surface-treated layer at the side that is opposed to the side where the polarizer is provided. Appropriate treatments can be suitably employed as the surface treatment depending on the intended use. Examples of the surface-treated layer include layers treated with a hard coating treatment, an antistatic treatment, an antireflection treatment, a diffusion treatment (i.e., anti-glare treatment), and the like. These surface treatments are conducted in the aim of preventing a screen from getting dirty and damaging. Further, these surface treatments are conducted in the aim of preventing the damage of viewability of a display screen caused by a room fluorescent lamp and sunlight reflected in the screen. As for the surface-treated layer, generally, the one in which a treatment agent for forming the surface-treated layer is adhered on a surface of a base film is used. The base film may also serve as the protective layer. Further, for example, the surface-treated layer may have a multilayer structure in which a hard coating layer is laminated on an antistatic treatment layer.

As described above, the liquid crystal panel of the present invention is a liquid crystal panel that includes a liquid crystal cell and an optical element. The optical element is the optical film of the present invention or the polarizing plate of the present invention, and the optical element is arranged at least one side of the liquid crystal cell. A schematic cross sectional view of FIG. 2 shows an example of the structure of the liquid crystal panel of the present invention. In FIG. 2, identical parts to those shown in FIG. 1 are indicated with identical numerals and symbols. As shown in FIG. 2, in this liquid crystal panel 30, polarizing plates 10 of the present invention are arranged at both of the visible side of a liquid crystal cell 41 (upper side in FIG. 2) and the backlight side of the liquid crystal cell 41 (lower side in FIG. 2) in a state where the optical films 13 are placed at the side of the liquid crystal cell 41. In the liquid crystal panel of this example, the polarizing plates of the present invention are arranged at both of the visible side and the backlight side of the liquid crystal cell. However, the present invention is not limited thereto. The liquid crystal panel of the present invention is applicable as long as the polarizing plate of the present invention is arranged at least one of the visible side and the backlight side of the liquid crystal cell.

Examples of the liquid crystal cell include an active matrix liquid crystal cell using a thin-film transistor, and the like. Further, examples of the liquid crystal cell include a simple matrix liquid crystal cell that is employed for a super-twisted nematic liquid crystal display, and the like.

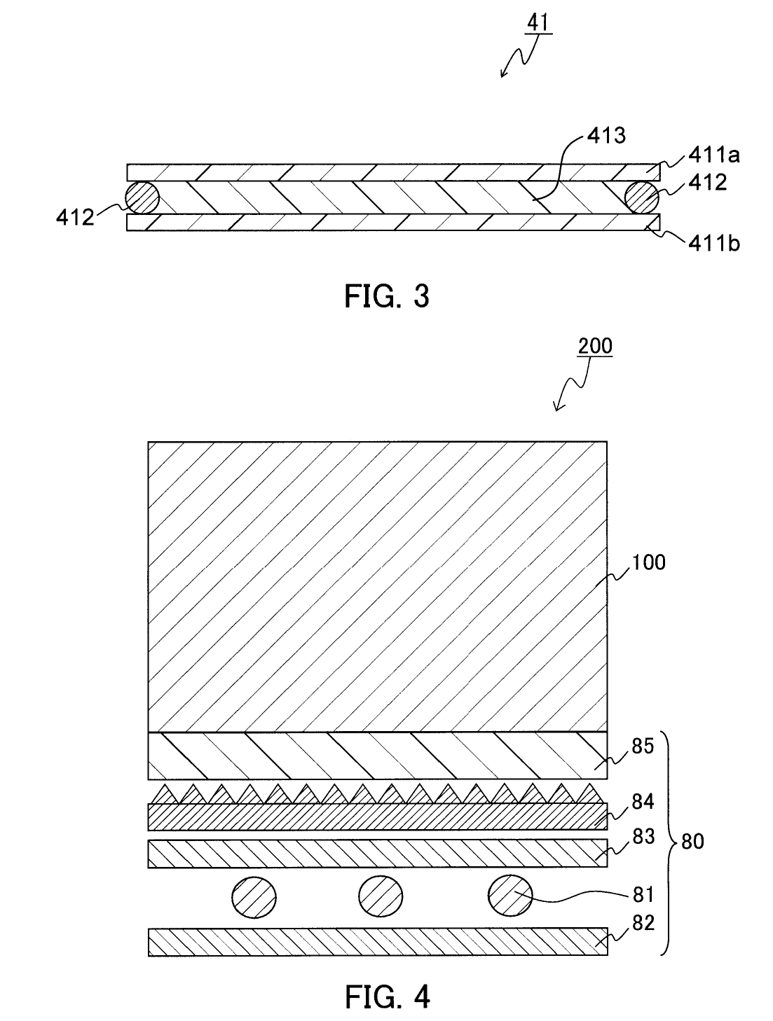

Generally, the liquid crystal cell has a structure in which a liquid crystal layer is interposed between a pair of substrates. FIG. 3 shows an example of the structure of the liquid crystal cell. As shown in FIG. 3, in a liquid crystal cell 41 of this example, a space is formed by arranging spacers 412 between a pair of substrates 411a and 411b. In the space, a liquid crystal layer 413 is interposed between the pair of substrates 411a and 411b. On the one of the substrates (active matrix substrate), for example, a switching element (e.g. TFT), a scanning line, and a signaling line may be provided, although they are not shown in FIG. 3. The switching element controls electrooptic properties of liquid crystal molecules, the scanning line sends a gate signal to the active element, and the signaling line sends a source signal to the active element. On the other one of the substrates, for example, a color filter may be provided.

The color filter may be provided on the active matrix substrate. Alternatively, for example, when a three color light source (may further contain multicolor light source) of RGB is used as a lighting means of a liquid crystal display as in the case of a field sequential method, the color filter may be omitted. A cell gap between the pair of substrates may be controlled, for example, by spacers. The cell gap is, for example, in the range from 1.0 μm to 7.0 μm. On the side of each substrate that is to be in contact with the liquid crystal layer, for example, an alignment film made from polyimide is provided. Alternatively, for example, when an initial alignment of liquid crystal molecules is controlled using a fringe electric field formed with a patterned transparent substrate, the alignment film may be omitted.

The refractive index of the liquid crystal cell preferably shows the relation of nz>nx=ny. According to the classification of drive modes, examples of the drive mode of the liquid crystal cell whose refractive index shows the relation of nz>nx=ny include a vertical alignment (VA) mode, a twisted nematic (TN) mode, a vertical alignment electrically controlled birefringence (ECB) mode, an optical compensation birefringent (OCB) mode, and the like. In the present invention, the drive mode of the liquid crystal cell is preferably the VA mode.

In the present invention, it is also preferable that the drive mode of the liquid crystal panel is an in-plane switching (IPS) mode.

The liquid crystal display of the present invention includes the polarizing plate or the liquid crystal panel of the present invention. A schematic cross sectional view of FIG. 4 shows an example of the structure of the liquid crystal display of the present invention. In FIG. 4, in order to make it clearly understandable, for example, the sizes and ratios of respective components differ from actual ones. As shown in FIG. 4, a liquid crystal display 200 is provided with at least a liquid crystal panel 100 and a direct type backlight unit 80 that is arranged at the one side of the liquid crystal panel 100. The direct type backlight unit 80 is provided with at least a light source 81, a reflection film 82, a diffusion plate 83, a prism sheet 84, and a brightness enhancement film 85. It is to be noted that the liquid crystal display 200 of this example shows a case in which a direct type backlight unit is used as the backlight unit. However, the present invention is not limited thereto, and the backlight unit may be a side light type backlight unit. The side light type backlight unit is provided with at least a light guide plate and a light reflector in addition to the components of the aforementioned direct type backlight unit. Some of the components shown in FIG. 4 may be omitted or replaced by other optical elements depending on the intended use such as a lighting method of a liquid crystal display, a drive mode of a liquid crystal cell, or the like as long as the advantages of the present invention can be obtained.

The liquid crystal display of the present invention may be a transmission type in which a screen is seen by irradiating the backlight side of the liquid crystal panel with light, a reflection type in which a screen is seen by irradiating the visible side of the liquid crystal panel with light, or a semi-transmission type that has both properties of the transmission type and the reflection type.

The liquid crystal display of the present invention can be used for any appropriate application. Examples of thereof include office equipment such as a PC monitor, a notebook PC, a copy machine, and the like; portable devices such as a mobile phone, a watch, a digital camera, a personal digital assistant (PDA), a handheld game machine, and the like; home electric appliances such as a video camera, a television set, a microwave oven, and the like; vehicle equipment such as a back monitor, a monitor for a car-navigation system, a car audio device, and the like; display equipment such as an information monitor for stores, and the like; security equipment such as a surveillance monitor, and the like; and nursing and medical equipment such as a monitor for nursing care, a monitor for medical use, and the like; and the like.

### EXAMPLES

Next, Examples of the present invention are described together with Comparative Examples. However, the present invention is not limited by the following Examples and Comparative Examples. Various physical properties and properties in the respective Examples and Comparative Examples were evaluated or measured by the following methods.

### <Alignment Δnxz of Optical Compensation Layer in Thickness Direction, Retardation Rthᵢ of Optical Compensation Layer in Thickness Direction, and Front Retardation Reᵢ of Optical Compensation Layer>

The alignment Δnxz of an optical compensation layer in the thickness direction, the retardation Rthᵢ of the optical compensation layer in the thickness direction, and the front retardation Re¹ of the optical compensation layer at the wavelength of 590 nm were measured using “AXOSCAN” (product name) produced by Axometrics, Inc.

### <Thickness>

The thickness was measured using a spectrophotometer for thin film “MCPD-2000” (product name) produced by Otsuka Electronics Co., Ltd.

### <ΔRth and ΔRe of Optical Compensation Layer>

A glass substrate was attached to one side of the optical film (optical compensation layer) via an adhesive agent. Then, a film of an acrylic resin having a lactone ring structure (LMMA) was attached to the other side of the optical compensation layer via an adhesive agent, and thereby an optical compensation layer with protective layer was obtained. Subsequently, this optical compensation layer with protective layer was allowed to stand still for 100 hours under an environment in which a temperature is 60° C. and a relative humidity is 90%. The retardation Rth_{f} of the optical compensation layer in the thickness direction and the front retardation Re_{f} of the optical compensation layer after allowing to stand still were measured using “AXOSCAN” (product name) produced by Axometrics, Inc., and the ΔRth and the ΔRe of the optical compensation layer were calculated.

### Example 1

### Optical Film

As a material for forming an optical compensation layer, a mixture containing a repeat unit represented by the structural formula (1), a polyvinyl alcohol resin whose degree of polymerization n is 4000, and a cross-linking agent (MBAA, produced by Wako Pure Chemical Industries, Ltd.) was used. It is to be noted that, in the mixture, 5% by weight of the cross-linking agent was added to the polyvinyl alcohol resin. As the polyvinyl alcohol resin, “JC40” (product name, degree of polymerization n of 4000) produced by JAPAN VAM & POVAL CO., LTD. was used. The mixture was dissolved in hot water of 95° C. and then cooled down. 7% by weight of the thus prepared solution was applied on a polycarbonate (PC) film base (“PANLITE FILM PC-2151”, product name, produced by TEIJIN CHEMICALS LTD.) so as to have a thickness of 70 μm, and this was subjected to free end stretching to stretch it 1.07 fold while drying at 80° C. for 2 minutes, then at 110° C. for 2 minutes, and then at 150° C. for 2 minutes. Subsequently, the polyvinyl alcohol resin was subjected to ultraviolet cross-linking with the cross-linking agent by irradiating the laminate with ultraviolet rays of 300 mJ/cm², and thereby obtained the laminate in which the optical compensation layer is laminated on the film base. Thereafter, an optical film was obtained by removing the optical compensation layer from the film base.

### Example 2

### Optical Film

Hydantoin epoxy acrylate (HYEA) was obtained by reacting 240 parts by weight of hydantoin epoxy resin represented by the following structural formula, 137 parts by weight of acrylic acid (produced by Wako Pure Chemical Industries, Ltd.), 0.2 parts by weight of methoquinone (produced by Seiko Chemical Co., Ltd.), and 1.4 parts by weight of benzyltrimethylammonium chloride (produced by Wako Pure Chemical Industries, Ltd.) at 90° C. As a material for forming an optical compensation layer, the thus obtained HYEA was used as a cross-linking agent. Except for this, 7% by weight of solution was obtained in the same manner as in Example 1. This solution was applied on the film base that is same as the film base used in Example 1 so as to have a thickness of 70 μm, and this was subjected to free end stretching to stretch it 1.07 fold while drying at 80° C. for 2 minutes, then at 110° C. for 2 minutes, and then at 150° C. for 2 minutes. Subsequently, the polyvinyl alcohol resin was subjected to ultraviolet cross-linking with the cross-linking agent by irradiating the laminate with ultraviolet rays of 300 mJ/cm², and thereby obtained the laminate in which the optical compensation layer is laminated on the film base. Thereafter, an optical film was obtained by removing the optical compensation layer from the film base.

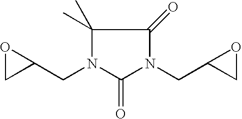

### Comparative Example 1

An optical film was obtained in the same manner as in Example 1 except that boric acid was added instead of MBAA and ultraviolet rays were not irradiated.

### Comparative Example 2

An optical film was obtained in the same manner as in Example 1 except that a cross-linking agent was not added.

### Comparative Example 3

An optical film was obtained in the same manner as in Example 1 except that boric acid was added instead of MBAA.

### Comparative Example 4

An optical film was obtained in the same manner as in Example 1 except that ultraviolet rays were not irradiated.

### Comparative Example 5

An optical film was obtained in the same manner as in Example 1 except that hydroxyethyl acrylamide (HEAA) having only one double bond was added instead of MBAA.

Types of the cross-linking agents used in Examples and Comparative Examples, cross-linking patterns in Examples and Comparative Examples, refractive index distributions of the optical films obtained in Examples and Comparative Examples, alignment Δnxz in the thickness direction, retardation Rthᵢ in the thickness direction, and front retardation Re¹, ΔRth, and ΔRe are summarized in the following Table 1. In Example 1, the optical film having a refractive index anisotropy satisfying nx>ny>nz was obtained. Further, the optical film showed high retardation developability such that Δnxz is 0.0115, which is large, and showed high retardation reliability such that ΔRth is 1.3 nm and ΔRe is 1.9 nm, which are small. Also in Example 2, the optical film having a refractive index anisotropy satisfying nx>ny>nz was obtained. The optical film showed high retardation developability such that Δnxz is 0.012, which is large, and high retardation reliability such that ΔRth is 1.8 nm and ΔRe is 3.0 nm, which are small. In contrast, in Comparative Example 1 in which thermal cross-linking was performed with boric acid and ultraviolet rays were not irradiated, the optical film showed low retardation developability such that Δnxz is 0.0079, which is small. In Comparative Example 2 in which the cross-linking agent was not added, the optical film showed low retardation reliability such that ΔRth is 21.6 nm and ΔRe is 8.1 nm, which are large. In Comparative Example 3 in which ultraviolet cross-linking was performed with boric acid, the optical film showed low retardation developability such that Δnxz is 0.0079, which is small, and low retardation reliability such that ΔRth is 23.6 nm and ΔRe is 8.8 nm, which are large. In comparative Example 4 in which thermal cross-linking was performed with MBAA and ultraviolet rays were not irradiated, the optical film showed low retardation reliability such that ΔRth is 21.3 nm and ΔRe is 7.0 nm, which are large. In Comparative Example 5 in which ultraviolet cross-linking was performed with HEAA, the optical film showed low retardation reliability such that ΔRth is 22.3 nm and ΔRe is 7.1 nm, which are large.

TABLE 1

| | Cross-linking | Cross-linking | Refractive index | | Rthᵢ | Reᵢ | ΔRth | ΔRe |
|---|---|---|---|---|---|---|---|---|
| | agent | pattern | distribution | Δnxz | (nm) | (nm) | (nm) | (nm) |
| Example 1 | MBAA | Ultraviolet | nx > ny > nz | 0.0115 | 141.0 | 51.2 | 1.3 | 1.9 |
| | | cross-linking | | | | | | |
| Example 2 | HYEA | Ultraviolet | nx > ny > nz | 0.012 | 139.0 | 54.3 | 1.8 | 3.0 |
| | | cross-linking | | | | | | |
| Comparative | Boric acid | Thermal | nx > ny > nz | 0.0079 | 144.9 | 56.5 | 2.2 | 2.5 |
| Example 1 | | cross-linking | | | | | | |
| Comparative | — | Ultraviolet | nx > ny > nz | 0.0115 | 152.0 | 55.5 | 21.6 | 8.1 |
| Example 2 | | cross-linking | | | | | | |
| Comparative | Boric acid | Ultraviolet | nx > ny > nz | 0.0079 | 147.3 | 57.8 | 23.6 | 8.8 |
| Example 3 | | cross-linking | | | | | | |
| Comparative | MBAA | Thermal | nx > ny > nz | 0.0111 | 150.9 | 50 | 21.3 | 7.0 |
| Example 4 | | cross-linking | | | | | | |
| Comparative | HEAA | Ultraviolet | nx > ny > nz | 0.0111 | 135.0 | 46.1 | 22.3 | 7.1 |
| Example 5 | | cross-linking | | | | | | |

As described above, the optical film of the present invention has high retardation developability and high retardation reliability, and uses a material that can use an environmentally-friendly solvent and that is inexpensive as compared to polyimide. Application of the optical film of the present invention, the polarizing plate, the liquid crystal panel, and the liquid crystal display using the optical film are not particularly limited and can be applied to a wide range of fields.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### REFERENCE NUMBER LIST

10 polarizing plate
11 protective layer
12 polarizer
13 optical film
30, 100 liquid crystal panel
41 liquid crystal cell
411a, 411b substrate
412 spacer
413 liquid crystal layer
80 backlight unit
81 light source
82 reflection film
83 diffusion plate
84 prism sheet
85 brightness enhancement film
200 liquid crystal display

What is claimed is:

1. An optical film, comprising an optical compensation layer having a refractive index anisotropy satisfying nx>ny>nz, wherein the optical compensation layer contains a polyvinyl alcohol resin subjected to ultraviolet cross-linking with a cross-linking agent having at least two double bonds,
where nx: a refractive index in a direction (a slow axis direction) in which an in-plane refractive index of the optical compensation layer reaches its maximum;
ny: a refractive index in a direction (a fast axis direction) that is orthogonal to the nx direction within a plane of the optical compensation layer; and
nz: a refractive index in a thickness direction of the optical compensation layer that is orthogonal to each of the nx and ny directions.

2. The optical film according to claim 1, wherein an alignment Δnxz of the optical compensation layer in a thickness direction represented by the following formula is 0.01 or more, where Δnxz is defined as Δnxz=nx−nz.

3. The optical film according to claim 1, wherein an amount of the cross-linking agent to be added to the polyvinyl alcohol resin is in the range from 0.5% by weight to 8% by weight.

4. The optical film according to claim 1, wherein an absolute value (ΔRth=|Rthᵢ−Rth_{f}|) of a difference between retardation (Rth_{f}) of the optical compensation layer in a thickness direction after allowing to stand still for 100 hours under an environment in which a temperature is 60° C. and a relative humidity is 90% and retardation (Rthᵢ) of the optical compensation layer in a thickness direction before allowing to stand still is 10 nm or less, where Rth is defined as Rth=(nx−nz)×d, where d: thickness (nm) of the optical compensation layer.

5. The optical film according to claim 1, wherein an absolute value (ΔRe=|Reᵢ−Re_{f}|) of a difference between front retardation (Re_{f}) of the optical compensation layer after allowing to stand still for 100 hours under an environment in which a temperature is 60° C. and a relative humidity is 90% and front retardation (Reᵢ) of the optical compensation layer before allowing to stand still is 5 nm or less, where Re is defined as Re=(nx−ny)×d, where d: thickness (nm) of the optical compensation layer.

6. The optical film according to claim 1, further comprising a transparent film base, wherein the optical compensation layer is formed on the transparent film base.

7. A polarizing plate, comprising a polarizer and the optical film according to claim 1.

8. A liquid crystal panel, comprising a liquid crystal cell and an optical element, wherein the optical element is the optical film according to claim 1, and the optical element is arranged at least one side of the liquid crystal cell.

9. A liquid crystal panel, comprising a liquid crystal cell and an optical element, wherein the optical element is the polarizing plate according to claim 7, and the optical element is arranged at least one side of the liquid crystal cell.

10. A liquid crystal display, comprising the optical film according to claim 1.

11. A liquid crystal display, comprising the polarizing plate according to claim 7.

12. A liquid crystal display, comprising the liquid crystal panel according to claim 8.

13. A liquid crystal display, comprising the liquid crystal panel according to claim 9.

14. A method for producing an optical film comprising an optical compensation layer having a refractive index anisotropy satisfying nx>ny>nz, comprising steps of:
forming a coating film by applying a material for forming the optical compensation layer containing a polyvinyl alcohol resin and a cross-linking agent having at least two double bonds on a base;
performing at least one of stretching and shrinking of a laminate of the base and the coating film; and
irradiating the laminate with ultraviolet rays after performing at least one of the stretching and the shrinking,
where nx: a refractive index in a direction (a slow axis direction) in which an in-plane refractive index of the optical compensation layer reaches its maximum;
ny: a refractive index in a direction (a fast axis direction) that is orthogonal to the nx direction within a plane of the optical compensation layer; and
nz: a refractive index in a thickness direction of the optical compensation layer that is orthogonal to each of the nx and ny directions.

15. The method for producing an optical film according to claim 14, wherein the cross-linking agent is added to the polyvinyl alcohol resin in the range from 0.5% by weight to 8% by weight.

16. The method for producing an optical film according to claim 14, wherein the material contains a solvent selected from the group consisting of ethanol and water.
